(19) United States
(12) Patent Application Publication
(10) Pub. No.: US 2026/0318467 A1
(43) Pub. Date: Oct. 15, 2026

(54) LINEAR POSITIONING STAGE WITH CARRIAGE AND CAM-BASED ADJUSTABLE TENSION APPARATUS

(71) Applicant: NATIONAL APERTURE INC., Sebastian, FL (US)

(72) Inventors: Dennis W. DAVIS, Palm Bay, FL (US); Andrey Lozovskiy, Parma, OH (US)

(21) Appl. No.: 19/643,605

(22) Filed: Apr. 9, 2026

Related U.S. Application Data
(60) Provisional application No. 63/787,313, filed on Apr. 11, 2025.

(51) Int. Cl. F16M 11/04; F16D 63/00

(52) U.S. Cl. CPC F16M 11/043; F16D 63/008; F16M 2200/027

(57) ABSTRACT

A cam-based adjustable tension apparatus for a linear positioning stage includes a leaf spring structure connected to a main carriage body of the linear positioning stage. Further, the apparatus includes a contact surface coupled to the leaf spring structure and configured to slide or roll against a rail of the linear positioning stage to guide the main carriage body along the rail. Also, a cam is rotatably couplable with the main carriage body. The cam defines a cam surface in contact with the leaf spring structure. A rotation of the cam about a cam axis of the cam varies an impinging force of the cam against the leaf spring structure enabling the leaf spring structure to flex with respect to the main carriage body and move or impinge the contact surface relative to the rail such that a preload force exerted by the contact surface on the rail is adjusted.

### CROSS-REFERENCE TO RELATED APPLICATIONS

The present application claims the benefit of U.S. Provisional Application No. 63/787,313, filed on April 11, 2025, entitled “CAM-ADJUSTABLE PRELOAD MECHANISM”, which is incorporated by reference herein in its entirety.

### BACKGROUND OF THE INVENTION

Linear positioning stages are widely used in fields, such as precision engineering, manufacturing, optics, semiconductor processing, medical devices, and instrumentation, for accurately moving a part or a device along a defined axis, for example, a linear axis. Commonly, a machining tolerance of one component of a linear positioning stage may deviate from an ideal dimension or a tolerance, causing such a component to develop play relative to one or more other components of the linear positioning stage. As an example, an inaccurate machining tolerance causes a carriage of the linear positioning stage to be improperly loaded relative to one or more rails or guiding tracks of the linear positioning stage. Such situations affect output and productivity while also increasing operational time and effort.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is an exemplary view of a linear positioning stage having a support structure and a carriage, in accordance with some embodiments;

FIG. 2 is an exemplary view of the linear positioning stage with the support structure removed, in accordance with some embodiments;

FIG. 3 is an exemplary view of the linear positioning stage with the support structure removed and with one or more components of the linear positioning stage in a partially exploded state with respect to one or more other components of the linear positioning stage, in accordance with some embodiments;

FIG. 4 is a plan view of a profile of a cam of the linear positioning stage illustrated in conjunction with a profile of a well of a main carriage body of the linear positioning stage, in accordance with some embodiments;

FIG. 5 is a cross-sectional view of the linear positioning stage, illustrating various internal components of the linear positioning stage, in accordance with some embodiments;

FIG. 6 is a perspective view of the cam in conjunction with a fastener of the linear positioning stage, in accordance with some embodiments;

FIG. 7 is a perspective view of the cam assembled inside the well of the main carriage body of the linear positioning stage by way of the fastener, in accordance with some embodiments;

FIG. 8 is a view of the linear positioning stage in conjunction with a tool to articulate the cam about a cam axis, in accordance with some embodiments; and

FIG. 9 is a view of another exemplary linear positioning stage, in accordance with one or more other embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments.

The apparatus and/or method components have been represented where appropriate by conventional symbols in the drawings, showing only those specific details that are pertinent to understanding the embodiments so as not to obscure the description with details that will be readily apparent to those of ordinary skill in the art having the benefit of the description herein.

### DETAILED DESCRIPTION OF THE INVENTION

The embodiments described herein are related to a linear positioning stage which allows the tuning of a preload force against a reference surface such as a rail or a precision rail. To this end, the linear positioning stage includes a cam (for example, variable diameter/radius cam), a roller wheel, and a leaf spring structure. A rotation of the cam causes the leaf spring structure and the roller wheel to flex and adjust a preload force against the rail. Tuning the preload force helps accommodate machining tolerances in various parts of the linear positioning stage, thereby optimizing the linear positioning stage for different conditions and types of use.

In one aspect, a cam-based adjustable tension apparatus for a linear positioning stage is described. The cam-based adjustable tension apparatus includes a leaf spring structure connected to a main carriage body of the linear positioning stage. The carriage further includes a contact surface and a cam. The contact surface is coupled to the leaf spring structure and is configured to be slide or roll against a rail of the linear positioning stage to guide the main carriage body along the rail. The cam is rotatably couplable with the main carriage body. The cam defines a cam surface in contact with the leaf spring structure. A rotation of the cam about a cam axis of the cam varies an impinging force of the cam against the leaf spring structure enabling the leaf spring structure to flex with respect to the main carriage body and move or impinge the contact surface relative to the rail such that a preload force exerted by the contact surface on the rail is adjusted.

In another aspect, a linear positioning stage is described. The linear positioning stage includes a support structure, at least one rail coupled to and extending longitudinally along a linear axis or a length of the support structure, and a carriage for the support structure. The carriage is configured to be loaded and moved along the rail. The carriage includes a main carriage body and a leaf spring structure connected to the main carriage body. The carriage further includes a contact surface coupled to the leaf spring structure. The contact surface is configured to slide or roll against the rail to guide the main carriage body along the rail. Further, the cam is rotatably couplable with the main carriage body. The cam defines a cam surface in contact with the leaf spring structure. A rotation of the cam about a cam axis of the cam varies an impinging force of the cam against the leaf spring structure enabling the leaf spring structure to flex with respect to the main carriage body and move or impinge the contact surface relative to the rail such that a preload force exerted by the contact surface on the rail is adjusted.

In yet another aspect, a carriage for a support structure of a linear positioning stage is described. The carriage includes a main carriage body and a leaf spring structure connected to the main carriage body. The carriage further includes an abutting structure defining a contact surface that is configured to slide or roll against a rail of the linear positioning stage to guide the main carriage body along the rail. Also, the carriage includes a force-adjusting element configured to be manipulated with respect to the main carriage body. A manipulation of the force-adjusting element varies an impinging force against the leaf spring structure enabling the leaf spring structure to flex with respect to the main carriage body and move the contact surface relative to the rail such that a preload force exerted by the contact surface on the rail is adjusted.

Reference will now be made in detail to specific embodiments or features, examples of which are illustrated in the accompanying drawings. Generally, corresponding reference numbers may be used throughout the drawings to refer to the same or corresponding parts, for example, 1, 1`, 1``, 101 and 201 could refer to one or more comparable components used in the same and/or different depicted embodiments.

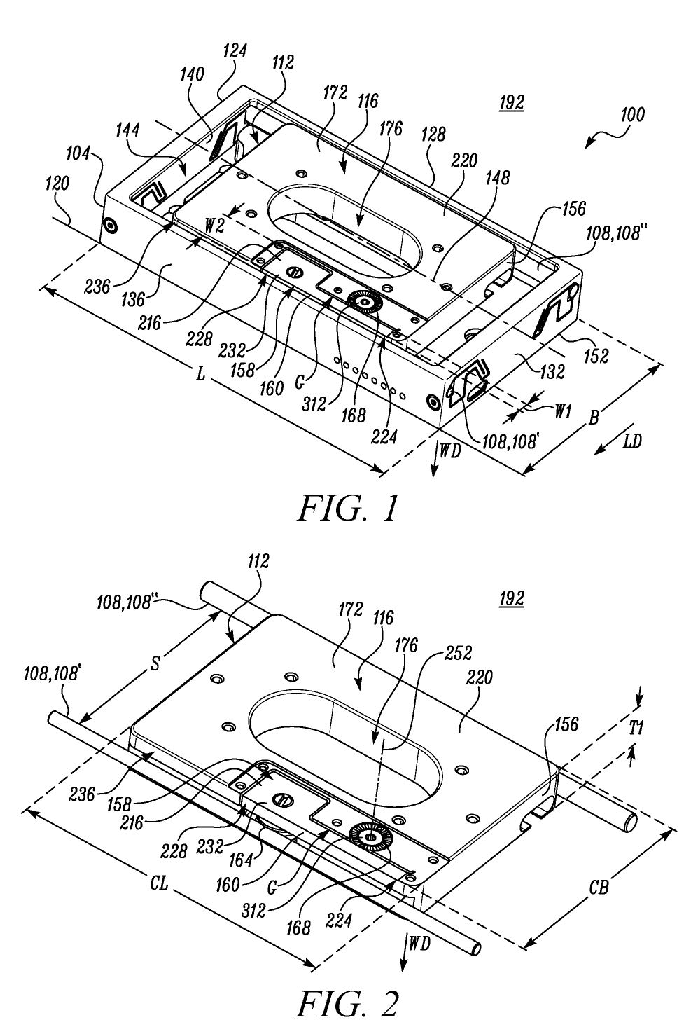

Referring to FIGS. 1 through 3, a linear positioning stage 100 is described. The linear positioning stage 100 is applicable in environments that require precision-controlled movement and positioning of an object (not shown). The object can include one or more of workpieces, sensors, substrates, wafers, electronic components, electrical devices, probes, jigs, tooling, fixtures, brackets, and/or other similar devices now known or in the future developed that require precise movement and positioning during an operation. The environments in which the linear positioning stage 100 is applied can include manufacturing, inspection, assembly, instrumentation, laboratory settings, and other such environments now known or in the future developed in which precision motion and positioning of one or more objects is needed. Although described herein with reference to the foregoing environments, the underlying concepts and mechanisms of the linear positioning stage 100 can be applied to a wide range of systems and/or subsystems, including those applied in the fields of automated production lines, robotics, mechatronics, semiconductor fabrication, nanoscale fabrication, packaging, material handling, automotive testing, optics, and as other such fields, now known or in the future developed, in which precise linear motion and/or positioning of one or more objects is desired. The linear positioning stage 100 is either manually driven, rotary motor driven, and/or linear motor driven.

An orientation of the linear positioning stage 100, as indicated in the figures of the present description, is exemplary and the linear positioning stage 100 can assume multiple other orientations depending upon a nature and/or a type of operation undertaken by the linear positioning stage 100. Further, as shown in FIGS. 1 through 3, the linear positioning stage 100 includes a support structure 104, one or more rails 108 and a carriage 112 for the support structure 104. Additionally, the linear positioning stage 100 defines a work surface 116 that supports (for example, immovably supports) the object during the movement and positioning. Details related to these components will now be described.

The support structure 104 serves as a main frame or base frame of the linear positioning stage 100 and is configured to be positioned over a floor 120, for example, a flat floor, during operations. The floor 120, without limitation, is representative of one or more of a surface defined over a table, a work platform, a work bench, and other such surfaces now known or in the future developed. The support structure 104 defines a first edge 124, a second edge 128, a third edge 132, and a fourth edge 136. As an example, the first edge 124, the second edge 128, the third edge 132, and the fourth edge 136, are laid out in a rectangular configuration (for example, a closed rectangular configuration) generally imparting a rectangular shape to the support structure 104. Also, the first edge 124, the second edge 128, the third edge 132, and the fourth edge 136, in conjunction define an inner periphery 140 of the support structure 104 that surrounds a central aperture 144 of the support structure 104. Given the rectangular shape of the support structure 104, the linear positioning stage 100 defines a length, L, and a breadth, B, with the second edge 128 and the fourth edge 136 being defined along the length, L, and the first edge 124 and the third edge 132 being defined along the breadth, B. According to some examples, the central aperture 144 also defines a rectangular shape. Although the rectangular shapes of the support structure 104 and the central aperture 144 are described above, the support structure 104 and the central aperture 144 can include various other shapes and configurations, as is contemplatable by someone skilled in the art based on the contents of the present description. Effectively, the rectangular shapes, as described for the support structure 104 and/or the central aperture 144, are exemplary, and need not be seen as limiting the concepts of the present description in any way.

The rails 108 correspond to two rails, namely a first rail 108` and a second rail 108``. The linear positioning stage 100 can include a higher or a lower number of rails 108. Each of the first rail 108` and the second rail 108`` is a linear or a straight rail and is positioned lengthwise relative to the support structure 104. In other words, the rails 108 are defined along the length, L, to extend longitudinally along the length, L, and/or along a linear axis 148 of the support structure 104 (see FIG. 1). Moreover, the first rail 108` and the second rail 108`` are coupled (for example, fixedly coupled) to the first edge 124 of the support structure 104 and are also coupled (for example, fixedly coupled) to the third edge 132 of the support structure 104, such that they extend longitudinally between the first edge 124 and the third edge 132, while being aligned along the second edge 128 and the fourth edge 136 and also to the linear axis 148. As an example, the first rail 108` and the second rail 108`` are parallel to each other and define a space, S, therebetween (see FIG. 2). According to some examples, the first rail 108` and the second rail 108`` are cylindrically shaped and/or define a curvilinear cross-section.

The carriage 112 defines the work surface 116 of the linear positioning stage 100 onto which the object is mounted during operation. The carriage 112 occupies a position within, or at least partially within, the central aperture 144 of the support structure 104, as shown. Also, the carriage 112 is slidably supported or engaged against the first rail 108` and the second rail 108`` to execute movement with respect to said rails 108 and the support structure 104. As an example, a portion of the carriage 112 is located within the space, S, defined between (for example, laterally between) the first rail 108` and the second rail 108``. In so doing, a direction of engagement of the carriage 112 with the first rail 108` and the second rail 108`` is in a lateral direction, LD, and/or in a direction defined by the breadth, B, as will also be understood by those skilled in the art from the forthcoming description. With the slidable engagement of the carriage 112 with the first rail 108` and the second rail 108``, the carriage 112 is configured to execute a movement along each of: the linear axis 148, the length, L, and the rails 108. Effectively, therefore, a movement of the carriage 112 along the first rail 108` and the second rail 108`` also translates into a movement of the work surface 116 and the object along the first rail 108` and the second rail 108``.

The expression ‘operation’ and/or ‘operations’ as used here and/or elsewhere in the present description, corresponds to and/or encompasses a myriad of operations, such as a measurement operation, a calibration operation, an inspection operation, a machining operation, and/or any such operation now known or in the future developed that the linear positioning stage 100 is configured to undertake and/or be part of. Although not limited, the carriage 112 remains accommodated, either partially or fully, within the central aperture 144 throughout the carriage’s movement relative to the support structure 104 and along the length, L. Moreover, the carriage 112 defines a carriage length, CL, extending along the length, L, of the linear positioning stage 100 and a carriage breadth, CB, extending along the breadth, B, of the linear positioning stage 100 (see FIGS. 1 and 2).

A state defined by the carriage 112 when the object is mounted atop the work surface 116 corresponds to a loaded state of the carriage 112. In the ‘loaded state’, the carriage 112 or the work surface 116 takes a load and/or a weight of the object. More particularly, the weight of the object sustained by the carriage 112 and/or by the work surface 116 in the loaded state defines a weight direction, WD. Although not limited, the weight direction, WD, of the object is orthogonal to the work surface 116 and/or to the linear axis 148, as exemplarily shown in FIG. 1. Also, the weight direction, WD, is directed downwards, for example, towards a lower end 152 (see FIG. 1) of the support structure 104 and/or the floor 120 over which the support structure 104 is positioned. The carriage 112 includes a main carriage body 156. The carriage 112 also includes a cam-based adjustable tension apparatus 158 including a leaf spring structure 160, a roller wheel 164, and a cam 168, details related to each of which shall now be described.

The main carriage body 156 defines a first outer surface 172. The first outer surface 172 forms one part of the work surface 116 of the linear positioning stage 110. Although not limited, the first outer surface 172 is planarly defined and/or includes a flat surface. During operation, the object is configured to be mounted atop the work surface 116, with the first outer surface 172 generally configured to accommodate and/or take up a bulk of a load and/or the weight of the object – such accommodation also depends upon the shape and size of the object and/or the type of the operation that is to be performed. In some embodiments, the main carriage body 156 defines a central opening 176. The central opening 176 extends from the first outer surface 172 and spans through and across a thickness, T1, of the main carriage body 156, as shown in FIG. 2. The central opening 176 is applicable to serve one or more purposes – for example, the central opening 176 facilitates a routing of one or more lines, such as power lines, fluid lines, and/or similar such lines now known or in the future developed, across the thickness, T1, of the main carriage body 156 and with respect to the object; for example, the central opening 176 receives portions of devices such as clamps and/or brackets (not shown) that are used to retain (for example, immovably retain) the object atop the work surface 116. A retention of the object, such as with the help of clamps and/or brackets, is well known to those skilled in the art and need not be described.

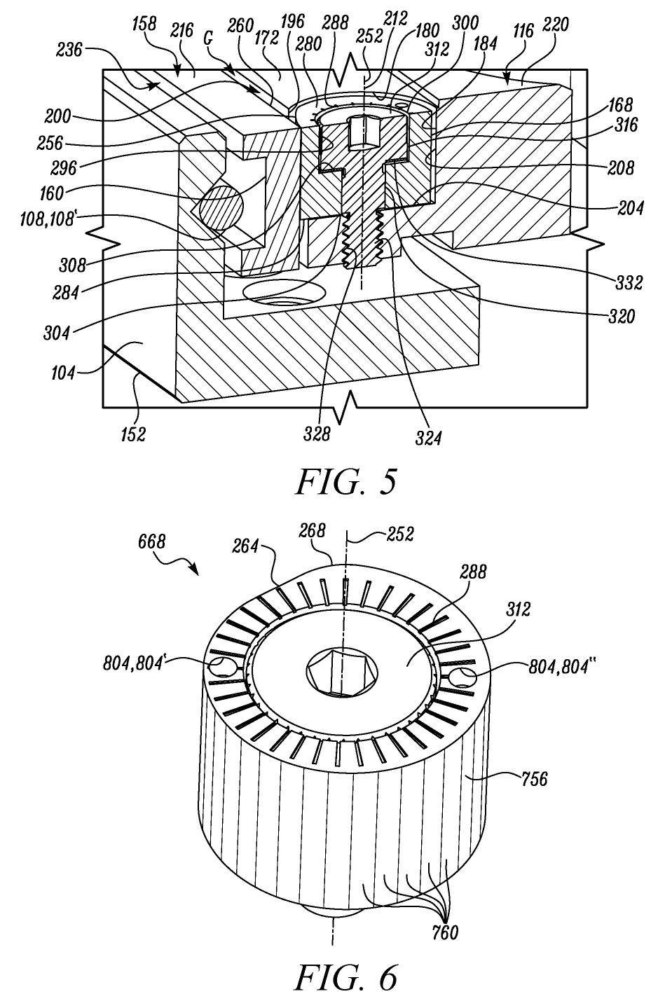

Referring to FIG. 5, and in conjunction with FIGS. 1 through 3, the main carriage body 156 defines a well 180. The well 180 is delimited by an inner surface 184 of the main carriage body 156, as shown. According to an example, the well 180 is a blind well that extends from the first outer surface 172 and partially into the thickness, T1, of the main carriage body 156. Although not limited, the well 180 is oriented along a thickness direction defined by the thickness, T1. The well 180 defines a well top opening 188 at the first outer surface 172 that enables the well 180 to be open to an outside 192 of the main carriage body 156 and/or the linear positioning stage 100. The well 180 also defines a well side opening 196 (see FIG. 5) that enables the well 180 to be open to a side (for example, a left side 200) of the main carriage body 156. The inner surface 184, delimiting the well 180, is defined by a base wall 204 and an annular wall 208 of the main carriage body 156. As shown, the annular wall 208 surrounds the base wall 204. In one example, the annular wall 208 defines a smooth, rotary surface around the base wall 204 and around an axis of the well 180 – the axis is referred to as a well axis 212.

Referring back to FIGS. 1 through 3, the leaf spring structure 160 is connected to the main carriage body 156 and is adapted to flex to be is at least partially deformable with respect to the main carriage body 156. The leaf spring structure 160 exhibits spring tension upon deformation. The leaf spring structure 160 forms or defines a second outer surface 216 that forms another part and/or a remaining part of the work surface 116 of the linear positioning stage 110. As with the first outer surface 172, the second outer surface 216 is planarly defined and/or includes a flat surface, as well. In one example, the first outer surface 172 and the second outer surface 216 are defined along a common plane 220 and/or are flush with each other to define the work surface 116 of the linear positioning stage 100 – as an example, a consistent and/or uniform gradient is defined across the work surface 116. In conjunction, therefore, the first outer surface 172 and the second outer surface 216 defines the work surface 116 of the linear positioning stage 100. According to one exemplary implementation, an area defined by the first outer surface 172 is larger than an area defined by the second outer surface 216.

According to some embodiments, the main carriage body 156 and the leaf spring structure 160 is formed from a single parent body (also referred to as a main stage) (not shown). To this end, and as an example, the leaf spring structure 160 is formed by wire cutting a part of such a single parent body such that a cutting seam is formed in the main stage dividing a first part of the main stage from a second part of the main stage. The first part corresponds to the main carriage body 156 and the second part corresponds to the leaf spring structure 160. Given that the main carriage body 156 and the leaf spring structure 160 are formed from the same, single parent body (and material), the leaf spring structure 160 extends integrally and contiguously from at least one section of the main carriage body 156. As an example, the leaf spring structure 160 is connected to a single section of the main carriage body 156.

In this regard, a part of the leaf spring structure 160 which is connected to the main carriage body 156 corresponds to a first end 224 of the leaf spring structure 160 and a part of the leaf spring structure 160 which is away from (and is independent of) the main carriage body 156 corresponds to a second end 228 of the leaf spring structure 160. Such connection imparts a cantilevered configuration to the leaf spring structure 160 with respect to the main carriage body 156. In some embodiments, the leaf spring structure 160 defines an island 232 at the second end 228 with respect to the main carriage body 156, and, therefore, a width, W1, of the leaf spring structure 160, when viewed along a direction of the carriage breadth, CB, or along a breadth direction, is smaller at the first end 224 when compared to a width, W2, of the leaf spring structure 160 at the second end 228. In other words, along the breadth direction, the leaf spring structure 160 defines a relatively narrower width, W1, at the first end 224 and relatively broader width, W2, at the second end 228.

It will be appreciated that the relatively narrower width, W1, at the first end 224 enables the leaf spring structure 160 to relatively easily flex with respect to the main carriage body 156. Also, according to an example, the leaf spring structure 160 is disposed along the carriage length, CL, and extends about halfway along one of the sides (for example, see a left side 236) of the carriage 112. In some examples, a material of the main stage or the single parent body includes metals, such as, aluminum, steel, stainless steel, iron, wrought iron, cast iron, and similar such materials now known or in the future developed. Alternatively, or in combination with one or more of such metals, the main stage or the single parent body can include one or more of: alloys, ceramics, polymers, composite materials, granite, engineered plastics, and/or other such materials now known or in the future developed.

In some embodiments, a gap, G, is defined between the main carriage body 156 and the leaf spring structure 160 (see FIGS. 1 through 3). The gap, G, is formed as a result of cutting the single parent body or the main stage and is defined at the cutting seam. Under normal conditions, for example, when there is no pressure of force acting against the leaf spring structure 160, the leaf spring structure 160 is in a default position or in a home position (for example, the position of the leaf spring structure 160 as shown in the FIGS. 1 through 3). Under working conditions, for example, when a force acts or is applied against the leaf spring structure 160, the leaf spring structure 160 flexes with respect to the main carriage body 156 to move away from the main carriage body 156. In the case of pressure application, therefore, a flexure of the leaf spring structure 160 away from the main carriage body 156 expands the gap, G, at the cutting seam and moves the leaf spring structure 160 to an extended position with respect to the main carriage body 156. Conversely, when the force is released from the leaf spring structure 160, the leaf spring structure 160 flexes with respect to the main carriage body 156 to return and move towards the main carriage body 156. In the case of force release, therefore, a flexure of the leaf spring structure 160 towards the main carriage body 156 closes the gap, G, at the cutting seam and moves the leaf spring structure 160 to a retracted position with respect to the main carriage body 156. Although not limited, it will be appreciated that the retracted position is one and the same as the home position.

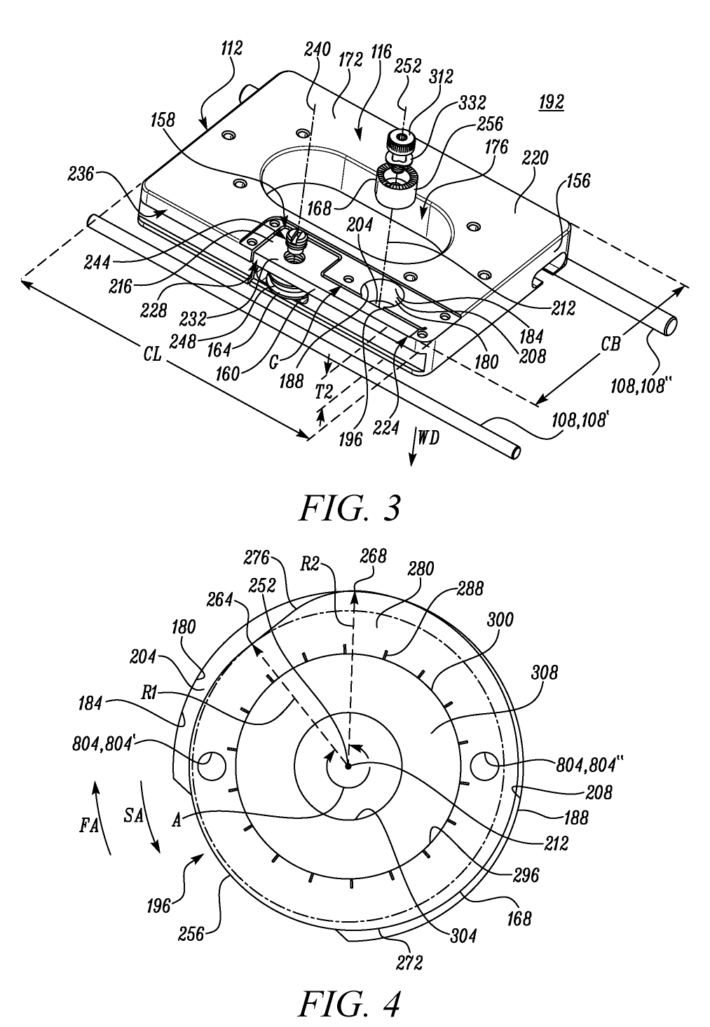

The roller wheel 164 is rotatably coupled to the leaf spring structure 160 and is freely rotatable about a wheel axis 240 (see FIG. 3) with respect to the leaf spring structure 160. Although not limited, the rotatable coupling of the roller wheel 164 with the leaf spring structure 160 is attained through an arrangement, such as a pin and bearing arrangement 244 (see FIG. 3), as is now known or in the future developed. According to an example, the roller wheel 164 or the wheel axis 240 defines a non-nutating axis of rotation. Also, a circumferential surface or a contact surface 248 (see FIG. 3) of the roller wheel 164 is configured to roll against a rail (for example, the first rail 108`). Such engagement guides the roller wheel 164 along the first rail 108` and thus moves the main carriage body 156 along the first rail 108`. As an example, the roller wheel 164 is rotatably coupled to the second end 228 or to the island 232 of the leaf spring structure 160 and the wheel axis 240 of the roller wheel 164 passes through a thickness, T2, of the leaf spring structure 160 (see FIG. 3). In other words, the wheel axis 240 passes through the thickness direction defined by the thickness, T2.

As an example, the contact surface 248 of the roller wheel 164 includes a machined surface which contacts the first rail 108`. In some embodiments, the roller wheel 164 exhibits precision machined interior surfaces that forms an outer bearing race for a single set of spherical bearings (not shown). In one example, the roller wheel 164 includes a bi-conical inner race, and the same is formed by two tapered set screws that are screwed into a housing that supports the roller wheel 164.

In some examples, the roller wheel 164 is omitted and the contact surface 248 is defined by a slider element (not shown) coupled to the leaf spring structure 160. As an example, such a slider element is fixedly and/or immovably coupled to the leaf spring structure 160. Moreover, a contact surface associated with such a slider element is configured to slide against the first rail 108` (as opposed to roll against the first rail 108`). Further, as an example, such a contact surface defines one of a flat and/or a planar profile. Alternatively, in such a case, the contact surface defines a curvilinear profile (for example, that complies with a curvilinear cross-section of the first rail 108` as described above). Details related to such a slider element are well contemplatable by those skilled in the art based on the contents of the present description and need not be described in further detail.

As an example, the wheel axis 240 is orthogonally defined and/or oriented with respect to the common plane 220. In that manner, the contact surface 248 operatively engages with the first rail 108` in the lateral direction, LD. In some embodiments, the thickness, T2, of the leaf spring structure 160 is the same (and/or has the same value) as the thickness, T1, of the main carriage body 156 – as an example, a measure of such a thickness starts from the common plane 220 and moves downward in a direction towards the lower end 152 or the floor 120. In some embodiments, the linear positioning stage 100 includes one or more roller wheels, similar to the roller wheel 164, rotatably coupled to the main carriage body 156 and which are configured to roll against the second rail 108`` to operatively engage with the second rail 108`` in a direction opposite to the direction indicated by the lateral direction, LD.

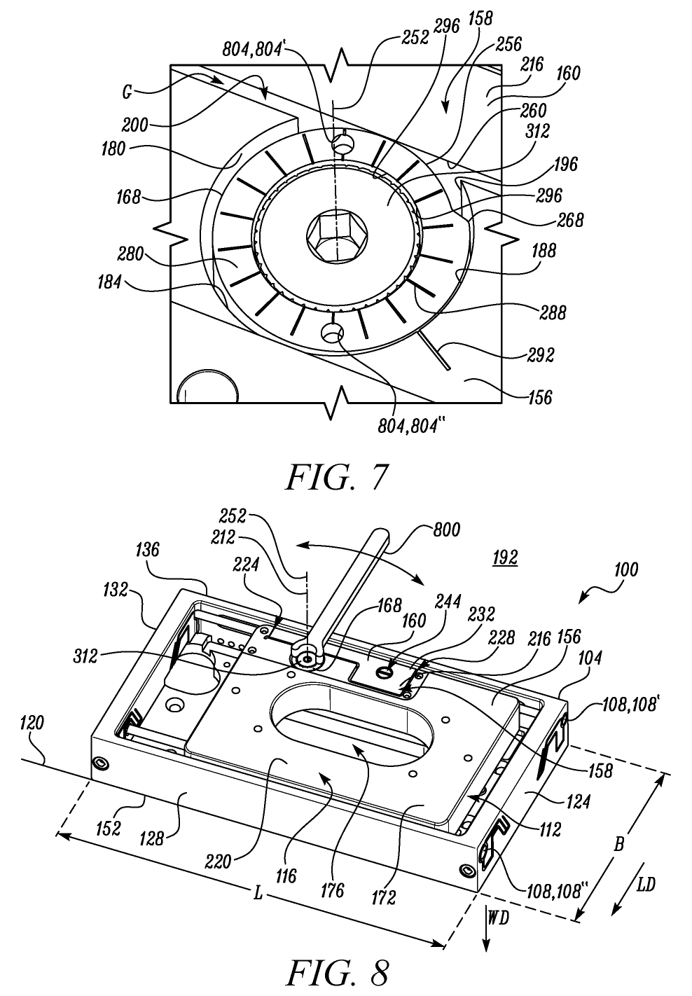

Referring to FIGS. 4 through 7, and also in conjunction with FIG. 1 through 3, the cam 168 is described. Although not limited, the cam 168 is a variable diameter cam or a variable radius cam and is rotatably coupled with the main carriage body 156. The cam 168 defines a cam axis 252 (also see FIGS. 2 and 3) around which the cam 168 rotates during operations. The cam axis 252 is defined in and along the thickness directions, T1 and T2. The cam 168 also defines a cam surface 256 extending around the cam axis 252. The cam surface 256 is adapted to lie in contact with the leaf spring structure 160 (for example, with an inner face 260 of the leaf spring structure 160 that is directed towards the main carriage body 156) (for example, see FIGS. 5 and 7). As an example, the cam surface 256 extends partially outwardly of the well 180 through the well side opening 196 and spans through gap, G, to make contact with the leaf spring structure 160.

Referring to FIGS. 4 and 6, the cam surface 256 defines a profile that incrementally or progressively increases in radius from a first curvature end 264 of the cam surface 256 to a second curvature end 268 of the cam surface 256. Such a profile of the cam 168 is referred to as a progressive profile 272. Moreover, it will be appreciated that a radius, R1, of the cam 168 at the first curvature end 264 is the smallest radius of the variable diameter cam (or of the cam 168) and a radius, R2, of the cam 168 at the second curvature end 268 is the largest radius of said variable diameter cam (or of the cam 168). According to an example, an angle, A, covered or swept from the first curvature end 264 to the second curvature end 268 along the progressive profile 272 of the cam surface 256 is more than 330 degrees and less than 360 degrees – such values for the angle, A, are provided for illustrative purposes and can include other values. In some embodiments, the cam surface 256 further defines a transition profile 276 extending between the first curvature end 264 and the second curvature end 268 on the cam surface 256. In some embodiments, and as viewed from an axial end view of the cam 168 in FIG. 4, the transition profile 276 is a profile that allows a reversion and/or a return of the leaf spring structure 160, lying conjugate to and in contact with the cam surface 256, to or towards the home position in a relatively smooth manner.

With the profile of the cam surface 256 described above and with the cam surface 256 in contact with the leaf spring structure 160, a rotation of the cam 168 about the cam axis 252 varies an impinging force of the cam 168 against the leaf spring structure 160 enabling the leaf spring structure 160 to flex with respect to the main carriage body 156 and move or impinge the contact surface 248 (for example, the roller wheel 164 or the slider element) relative to the first rail 108` such that a preload force exerted by said contact surface 248 on the first rail 108` is adjusted. More particularly, said rotation selectively corresponds to and/or encompasses both conditions – a first rotation of the cam 168 in a first angular direction, FA, as shown in FIG. 4, about the cam axis 252 and a second rotation of the cam 168 in a second angular direction, SA, as shown in FIG. 4, about the cam axis 252. The second angular direction, SA, is opposite (for example, angularly opposite) to the first angular direction, FA.

The first rotation, in which the cam surface 256 is varied from the first curvature end 264 towards the second curvature end 268 (along the progressive profile 272), induces the impinging force against the leaf spring structure 160 enabling the leaf spring structure 160 to flex away from the home position to the extended position with respect to the main carriage body 156 and push the contact surface 248 (for example, the roller wheel 164 or the slider element) against the first rail 108` such that the preload force exerted by said contact surface 248 on the first rail 108` is increased. Conversely, the second rotation, in which the cam surface 256 is varied from the second curvature end 268 towards the first curvature end 264 (also along the progressive profile 272), releases and/or reduces the impinging force against the leaf spring structure 160 enabling the leaf spring structure 160 to revert towards the home position with respect to the main carriage body 156 and move the contact surface 248 (for example, the roller wheel 164 or the slider element) away from the first rail 108` such that the preload force exerted by said contact surface 248 on the first rail 108` is decreased.

In some embodiments, the cam 168 includes a first axial surface 280 and a second axial surface 284 opposite to the first axial surface 280 (see FIG. 5). A height of the cam 168 is defined between the first axial surface 280 and the second axial surface 284. When the cam 168 is assembled or rotatably coupled with the main carriage body 156, the height of the cam 168 is aligned along the thickness direction defined by the thickness, T1, such that the first axial surface 280 is exposed to the outside 192 of the linear positioning stage 100, while the second axial surface 284 is directed away from the outside 192 towards a portion of the main carriage body 156. Also, in some embodiments, first axial surface 280 defines a rotary scale 288 (see FIG. 6) about the cam axis 252. The rotary scale 288 allows an operator of the cam 168 to observe and/or objectively gauge an extent to which the cam 168 is to be rotated for the application of preload force against the leaf spring structure 160. In some embodiments, a reference mark 292 (see FIG. 7) is provided on the main carriage body 156 (and/or on the first outer surface 172 of the main carriage body 156) against which the rotary scale 288 is matched and/or tallied so as to determine the extent to which the cam 168 is to be rotated (or is already rotated at any given point) for the application of the preload force against the leaf spring structure 160.

As shown in FIGS. 5 and 7, and, in some embodiments, the cam 168 is positioned within the well 180 of the main carriage body 156 such that the first axial surface 280 is positioned flush with the work surface 116 of the linear positioning stage 100 and/or with the first outer surface 172 of the main carriage body 156. Optionally, the first axial surface 280 is positioned at a lower elevation relative to the work surface 116 of the linear positioning stage 100 and/or relative to the first outer surface 172 of the main carriage body 156. In so doing, the cam 168 refrains from interference with the object during operations. In such cases, where the cam 168 is positioned within the well 180, the second axial surface 284 is directed towards the base wall 204, and the first axial surface 280 is directed away from the base wall 204 towards the outside 192. Also, when the cam 168 is positioned within the well 180, the cam axis 252 is aligned with the well axis 212.

According to some examples, the cam 168 defines a bore 296 (see FIGS. 4 and 5), for example, a through bore, that extends from the first axial surface 280 to the second axial surface 284. Further, the cam 168 defines a first opening 300 of the bore 296 at the first axial surface 280 and a second opening 304 of the bore 296 at the second axial surface 284. As an example, the bore 296 is a stepped bore and defines a stepped surface 308 (see FIGS. 4 and 5) such that the first opening 300 is larger (for example, in area) than the second opening 304. Moreover, in such cases, a fastener 312 (of the carriage 112) is further applied to retain the cam 168 immovably with the base wall 204. According to an example, the fastener 312 includes a shoulder screw and defines a head portion 316, a shoulder portion 320, and a threaded end 324 (see FIG. 5). The fastener 312 is at least partially positionable through the bore 296 and is passable through the base wall 204 of the well 180 to retain the cam 168 immovably with the base wall 204 of the well 180.

In an assembly of the cam 168 within the well 180 of the main carriage body 156, the head portion 316 of the fastener 312 sits on or above the stepped surface 308 while the shoulder portion 320 of the fastener 312 passes through at least part of the bore 296 and the threaded end 324 enters at least partially into the base wall 204 of the well 180. As an example, the threaded end 324 of the fastener 312 is threadably coupled to a threaded hole 328 (see FIG. 5) formed in the base wall 204 to enable the fastener 312 to retain the cam 168 with the base wall 204. Furthermore, and in some embodiments, the carriage 112 includes a wave washer 332 (see FIGS. 3 and 5) positioned in between the head portion 316 and the stepped surface 308 when the head portion 316 of the fastener 312 sits above the stepped surface 308 to securely lock the cam 168 with the base wall 204 and/or with the main carriage body 156 and resist loosening of the cam 168 owing to operational vibrations. According to some embodiments, the annular wall 208, the head portion 316, and the shoulder portion 320 correspondingly define rotary surfaces such that the cam 168 is rotatable and slidable relative to the fastener 312 about the cam axis 252 and within the well 180.

Referring to FIG. 6, a cam 668 is described. All description related to the cam 168 is suitably applicable to the cam 668, and, wherever possible, same reference numerals are used to refer to the same or like parts. However, the cam 668 forms one or more exceptions in that the cam 668 defines a cam surface 756 having multiple flat faces 760 instead of being rotationally smooth as the cam surface 256 (not all flat faces 760 are marked). As an example, the flat faces 760 are arranged serially one after the other (for example, with no intervening surface therebetween) in a rotational array about the cam axis 252. Moreover, each flat face 760 of the cam surface 756 extends and/or is aligned along the cam axis 252. When rotating the cam 668 during operations, the flat faces 760 permit quantized values of the preload force to be applied against the leaf spring structure 160, with each flat face 760 corresponding to a particular measure of the preload force of the cam surface 756 against the leaf spring structure 160. In some embodiments, the rotary scale 288 corresponds to the flat faces 760 on the cam surface 756.

Referring to FIG. 8, and also in conjunction with FIGS. 4, 6, and 7, in some embodiments, the linear positioning stage 100 includes a tool 800 to rotate the cam 168. To this end, the cam 168 further defines an engagement feature 804. The engagement feature 804 includes at least two slots 804`, 804`` extending into the body of the cam 168 (and cam 668) from the first axial surface 280 of the cam 168. The engagement feature 804 can include additional slots. Although not limited, the slots 804`, 804`` are located diametrically opposite to each other and are defined across the first axial surface 280 of the cam 168, as shown. The tool 800 defines a mating arrangement (not shown) to engage with the engagement feature, such that when engaged with the engagement feature, the tool 800 is used to twist and rotate the cam 168 about the cam axis 252. As an example, the mating arrangement includes at least two protrusions (to correspond to the two slots 804`, 804``). When a rotation of the cam 168 is needed, the protrusions are inserted into the slots 804`, 804`` such that the tool 800 engages with the cam 168. Thereafter, the tool 800 is rotated, for example, about the cam axis 252, such that torque is induced into the cam 168 for the cam 168 to rotate in or according to the direction of the torque.

During operations, and in further detail, when there is a need to adjust the preload force of the contact surface 248 (for example, the roller wheel 164 or the slider element) against the first rail 108`, an operator rotates the cam 168 to either increase or decrease loading on the first rail 108`. To this end, and assuming there is a need to increase the preload force, the operator partially unscrews or dislodges the fastener 312, for example, by using an Allen key, and/or any similar tool now known or in the future developed. In such a case, the well top opening 188 provides unrestricted access to such a tool. Once said tool is engaged with the head portion 316 of the fastener 312 and turned/twisted thereafter, a tension between the fastener 312 and the cam 168 is released and/or reduced. As a result, the cam 168 (even while being accommodated within the well 180) becomes relatively free to be rotated about the cam axis 252. With the cam surface 256 remaining in contact with the leaf spring structure 160, the tool 800, as shown in FIG. 8, is then used to engage with the cam 168 as described above and is then used to rotate the cam 168 in the first angular direction, FA (for example, see FIG. 4). The rotary surfaces of the annular wall 208, the head portion 316, and the shoulder portion 320 ensure that said rotation (for example, the first rotation) of the cam 168 is free from any obstruction. The resulting first rotation is accomplished with the help of the rotary scale 288, and, optionally with the use of the reference mark 292, as the operator applies torque on the tool 800 to rotate the cam 168 up to a desired rotary position.

During the rotation (for example, the first rotation) of the cam 168, the cam surface 256 impinges against the leaf spring structure 160 to induce the impinging force enabling the leaf spring structure 160 to flex away from the home position to the extended position with respect to the main carriage body 156 and push the contact surface 248 (for example, the roller wheel 164 or the slider element) against the first rail 108` such that the preload force exerted by said contact surface 248 on the first rail 108` is increased. It will be appreciated that a reaction arising from the impinging force enables roller wheels (not shown) engaged with the second rail 108`` to also increase a preload force against the second rail 108``, thus stabilizing the carriage 112 against each of the first rail 108` and the second rail 108``. Once the cam 168 attains the desired rotary position, the tool 800 is released and the fastener 312 is re-tightened (for example, by using the Allen key) into the well 180 and/or into the base wall 204 of the well 180 to also press and retain the cam 168 immovably with the base wall 204 of the well 180 in the desired rotary position. When there is a need to decrease the preload force, the above-described operation is suitably reversed.

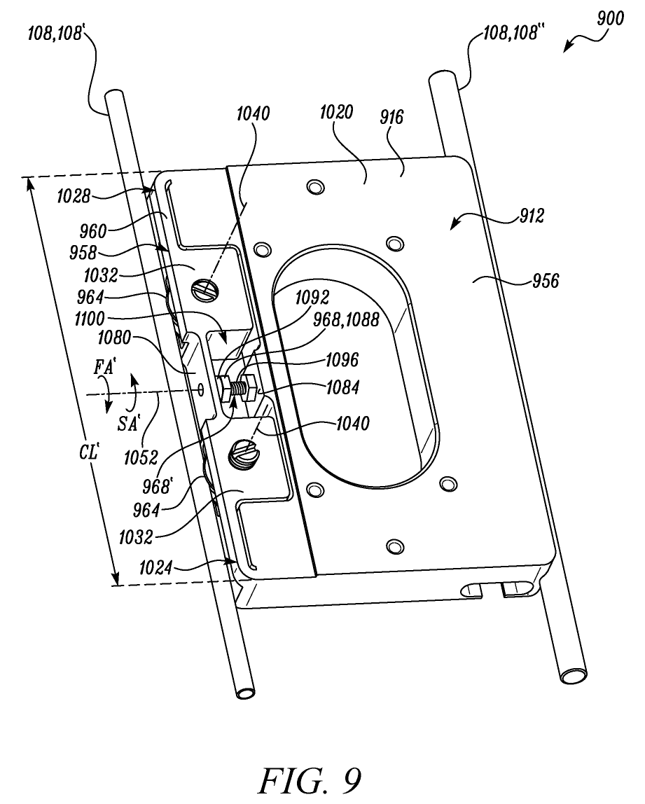

Referring to FIG. 9, parts of a linear positioning stage 900 is described in accordance with an alternate embodiment of the present description. The linear positioning stage 900 is similar to the linear positioning stage 100 described above, and, thus wherever possible, the same reference numerals will be used. The linear positioning stage 900 includes a carriage 912 with a main carriage body 956 and a cam-based adjustable tension apparatus 958 having a leaf spring structure 960. For example, the main carriage body 956 and the leaf spring structure 960 of the linear positioning stage 900 is formed similarly as that of the linear positioning stage 100, in that the main carriage body 956 and the leaf spring structure 960 are formed by wire cutting a corresponding main stage, as has been described for the linear positioning stage 100 above. The leaf spring structure 960 is also disposed along the corresponding carriage length, CL`.

However, the leaf spring structure 960 extends more than halfway (for example, to extend about a full way) along one of the sides (for example, see a corresponding left side) of the carriage 912. Moreover, the leaf spring structure 960 defines ends, for example, a third end 1024 and a fourth end 1028, each of which are connected, for example, integrally, to the main carriage body 956 to extend contiguously from the main carriage body 956. Such connection imparts a simply supported configuration to the leaf spring structure 960 with respect to the main carriage body 956. The leaf spring structure 960 defines two islands 1032. The linear positioning stage 900 further includes two roller wheels 964 (each similar to the roller wheel 164). The roller wheels 964 are correspondingly rotatably coupled to the islands 1032 of the leaf spring structure 960 and are able to freely rotate about their corresponding wheel axes 1040 with respect to the leaf spring structure 960. An arrangement and structure of the roller wheels 964 remains similar to the structure and arrangement of the roller wheel 164. For example, the wheel axes 1040 of the roller wheels 964 are orthogonally defined and/or oriented with respect to the corresponding common plane 1020 of the carriage 912 or the associated work surface 916 associated with the linear positioning stage 900 such that they extend through the thickness (similar to the thickness, T2) of the leaf spring structure 960. Additionally, the leaf spring structure 960 defines a bridge 1080 spanning between the islands 1032 of the leaf spring structure 960 to which the roller wheels 964 are rotatably coupled.

The main carriage body 956 defines a left side face 1084 on the left side, as shown, and a cam 968 of the linear positioning stage 900 is rotatably coupled with respect to the left side face 1084. As a result, a cam axis 1052 defined by the cam 968 extends into the main carriage body 956 in the corresponding breadth direction defined by the carriage 912. Moreover, the cam 968 is part of a screw assembly 968` that defines a cam surface (not visible in the view of FIG. 9) in contact with the leaf spring structure 960 and/or with the bridge 1080 of the leaf spring structure 960. To this end, and, as an example, the cam 968 defines or includes a screw 1088 and an abutting screw end 1092 positioned over a head portion of the screw 1088. The abutting screw end 1092 defines the corresponding cam surface that abuts the bridge 1080. The screw 1088 is threadably coupled to a stud 1096 extending outwards of the left side face 1084 of the main carriage body 956 and is rotatable to be linearly movable relative to the stud 1096. A rotation of the cam 968 (or the screw 1088) about the cam axis 1052 and around the stud 1096 varies an impinging force of the cam 968 (or the screw 1088) against the leaf spring structure 960 (and/or the bridge 1080) enabling the leaf spring structure 960 to flex with respect to the main carriage body 956 and move the roller wheels 964 relative to the first rail 108` such that a preload force exerted by the roller wheels 964 on the first rail 108` is adjusted.

Similar to the working of the cam 168, the rotation of the cam 968 selectively corresponds to a first rotation of the cam 968 in a first angular direction, FA`, about the cam axis 1052 and a second rotation of the cam 968 in a second angular direction, SA`, about the cam axis 1052. The second angular direction, SA`, is opposite to the first angular direction, FA`. More particularly, the first rotation induces the impinging force against the bridge 1080 of the leaf spring structure 960 enabling the leaf spring structure 960 to flex away from a corresponding home position to a corresponding extended position with respect to the main carriage body 956 and push the roller wheels 964 against the first rail 108` such that the preload force exerted by the roller wheels 964 on the first rail 108` is increased. The second rotation reduces the impinging force against the bridge 1080 of the leaf spring structure 960 enabling the leaf spring structure 960 to revert towards the corresponding home position with respect to the main carriage body 956 and move the roller wheels 964 away from the first rail 108` such that the preload force exerted by the roller wheels 964 on the first rail 108` is decreased.

During operations, when there is a need to adjust the preload force of the roller wheels 964 against the first rail 108`, an operator rotates the cam 968 (or the screw 1088) to either increase or decrease loading on the first rail 108`. To this end, and assuming there is a need to increase the preload force, the operator uses a suitable tool such as a wrench or a spanner (not shown) and rotates the cam 968 or the screw 1088 in the first angular direction, FA`. As a result, the cam 968 or the screw 1088 moves around the stud 1096 and in turn moves away from the left side face 1084 of the main carriage body 956, causing the abutting screw end 1092 to move towards and/or impinge against the bridge 1080. This in turn induces an impinging force against the leaf spring structure 960 (or the bridge 1080) enabling the leaf spring structure 960 to flex away from the corresponding home position to the corresponding extended position with respect to the main carriage body 956 and push the roller wheels 964 against the first rail 108` such that the preload force exerted by the roller wheels 964 on the first rail 108` is increased. A reaction arising from the impinging force enables one or more roller wheels (not shown) engaged with the second rail 108`` to also increase a preload force against the second rail 108``, in turn stabilizing the carriage 912 against each of the first rail 108` and the second rail 108``. When there is a need to decrease the preload force, the above-described operation is suitably reversed.

In the case of the cam 968, the operator approximates the displacement of the bridge 1080 based on a pitch of the thread on the stud 1096. Also, as the resulting force (for example, the impinging force) induces friction against the rotation of the screw 1088 (and within one or more of the associated elements, such as bearing elements, of the screw assembly 968`), a torque required to turn wrench or spanner will also increase. Based on such increased torque, the operator determines or gauge (for example, by instinct) the displacement of the cam 968 or the screw 1088 and an extent to which the cam 968 has impinged against the leaf spring structure 960 (or the bridge 1080). In some embodiments, however, a scale, for example, a linear scale (not shown), can be positioned under the screw assembly 968` and be made viewable through a window 1100 delimited between the left side face 1084, the bridge 1080, and the two islands 1032, as shown, through which the operator can view said linear scale and gauge an extent to which the cam 968 and/or the screw 1088 needs to be rotated.

By way of incorporating a mechanism that includes the cams, for example, either the variable diameter cam (for example, cam 168) and/or the screw assembly (for example, cam 968), the carriage 112, 912 and/or the linear positioning stage 100, 900 offers preload tunability. Preload tunability helps adjust load between various parts and components of the linear positioning stage 100, 900 through the suitable manipulation of the cam 168, 968, in turn compensating for machining tolerances between those parts and components. Such a mechanism enables variable and/or precisely calibrated preload to be induced against the rails 108, for example, the first rail 108` and the second rail 108``. This is because at least one of the rails 108, for example, the first rail 108`, serves as a primary reference rail to establish precision for the linear translation of the carriage 112, 912. The carriage 112, 912, having such a cam mechanism, inherently provides the ability to adjust the preload for different conditions of use. Different conditions include, without limitation, the use of different objects with differing weights and/or the use of the linear positioning stage 100, 900 in different orientations.

Although not limited, the roller wheel 164, 964 and/or the slider element serves as an abutting structure having the contact surface 248 which is configured to either roll or slide against the first rail 108` to guide and move the carriage 112, 912 along the first rail 108`. By way of addressing the roller wheel 164, 964 and/or the slider element as the abutting structure, the present description also envisages the use of a variety of components, structures, and/or mechanisms now known or in the future developed, apart from the roller wheel 164, 964 and/or the slider element, to accomplish functions as have been described above for the roller wheel 164, 964 and/or the slider element. In one example, the slider element is integrally formed with the leaf spring structure 160 such that the slider element directly contacts the first rail 108` to slide against the first rail 108`. When applying the slider element, the roller wheel 164, 964, and their configurations described herein, can be omitted; conversely, when applying any of the configurations of the roller wheel 164, 964, the slider element can be omitted. Similar such options and/or variations for the roller wheel 164, 964 and/or the slider element is contemplatable by those skilled in the art, with each such option and/or variation suitably falling within the ambit of the claimed subject matter.

Further, when viewing the linear positioning stages 100, 900 independently of each other, it will be appreciated that the cam 168 and the screw 1088 (for example, in conjunction with the abutting screw end 1092) correspondingly serve as force-adjusting elements of the linear positioning stages 100, 900. Usage of expression ‘force-adjusting elements’ also envisages the use of a variety of other components and/or mechanisms now known or in the future developed, apart from the cam 168 and the screw 1088, to accomplish functions as have been described above for the cam 968 and the screw 1088.

It will be appreciated that the term ‘preload’, as used in the present description, corresponds to a tension created in the carriage 112, 912 of the linear positioning stage 100, 900 to facilitate and/or enhance kinematic/semi-kinematic behavior of the carriage 112, 912 during motion (for example, during the linear motion along the linear axis 148). Such enhancement is attained by reducing tolerances and play between the components, effectively inducing compliance of various contacting components, of the linear positioning stage 100, 900. Moreover, such tension is supplied by one or more of the components of the carriage 112, 912, as has been described above. The expression ‘kinematic/semi-kinematic behavior’ refers to the application of kinematic principles, including constraining motion in terms of degrees of freedom, so as to achieve precision motion, such as linear motion, with appropriate mechanical compliance and mitigated play to maintain contact integrity and motion accuracy of one component with respect to one or more other components of the linear positioning stage 100, 900.

It will be appreciated that preload force is applied in the breadth direction or in the lateral direction, LD, from the roller wheel(s) 164, 964 to the first rail 108`, which corresponds to a force acting in a radial direction in the case of the cam 168 and in an axial direction in the case of the cam 968 (or the screw 1088). An increased preload force results in a commensurately increased top load carrying capacity and motion precision of the carriage 112, 912 while also increasing the friction coefficient that resists linear motion of the carriage 112, 912 along the rails 108. A decreased preload force results in a commensurately decreased top load carrying capacity and motion precision while also decreasing the friction coefficient that eases linear motion of the carriage 112, 912 along the rails 108. A decreased preload force can be useful when the linear positioning stage 100, 900 is mounted on its side and the object supported by the carriage 112, 912 exerts weight towards one of the edges, for example, the second edge 128 or the fourth edge 136, rather than the towards the lower end 152, or, in other words, when the weight direction, WD, of the object is aligned along the work surface 116, 916.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises”, “comprising”, “has”, “having”, “includes”, “including”, “contains”, “containing”, or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the description. This method is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby

incorporated into the Detailed Description, with each claim standing on its own as a separately claimed subject matter.

We claim:

1. A cam-based adjustable tension apparatus for a linear positioning stage, the cam-based adjustable tension apparatus comprising:
a leaf spring structure connected to a main carriage body of the linear positioning stage;
a contact surface coupled to the leaf spring structure and configured to slide or roll against a rail of the linear positioning stage to guide the main carriage body along the rail; and
a cam rotatably couplable with the main carriage body, the cam defining a cam surface in contact with the leaf spring structure, wherein
a rotation of the cam about a cam axis of the cam varies an impinging force of the cam against the leaf spring structure enabling the leaf spring structure to flex with respect to the main carriage body and move or impinge the contact surface relative to the rail such that a preload force exerted by the contact surface on the rail is adjusted.

2. The cam-based adjustable tension apparatus of claim 1, wherein
the rotation selectively corresponds to a first rotation of the cam in a first angular direction about the cam axis and a second rotation of the cam in a second angular direction about the cam axis, the second angular direction being opposite to the first angular direction,
the first rotation induces the impinging force against the leaf spring structure enabling the leaf spring structure to flex away from a home position to an extended position with respect to the main carriage body and push the contact surface against the rail such that the preload force exerted by the contact surface on the rail is increased, and
the second rotation reduces the impinging force against the leaf spring structure enabling the leaf spring structure to revert towards the home position with respect to the main carriage body and move the contact surface away from the rail such that the preload force exerted by the contact surface on the rail is decreased.

3. The cam-based adjustable tension apparatus of claim 1, wherein
the main carriage body defines a first outer surface and the leaf spring structure defines a second outer surface, and
the first outer surface and the second outer surface are defined along a common plane and are flush with each other defining a work surface of the linear positioning stage.

4. The cam-based adjustable tension apparatus of claim 1, wherein the cam includes a first axial surface and a second axial surface opposite to the first axial surface, the first axial surface exposed to an outside of the linear positioning stage and defining a rotary scale about the cam axis.

5. The cam-based adjustable tension apparatus of claim 1, wherein the cam includes a first axial surface and a second axial surface opposite to the first axial surface, the first axial surface exposed to an outside of the linear positioning stage, and
the main carriage body defines a well delimited by an inner surface of the main carriage body, and the cam is positioned within the well such that the first axial surface is positioned either flush with a work surface of the linear positioning stage or is positioned at a lower elevation relative to the work surface of the linear positioning stage.

6. The cam-based adjustable tension apparatus of claim 5, wherein
the inner surface is defined by a base wall and an annular wall of the main carriage body, the annular wall surrounds the base wall, the second axial surface is directed towards the base wall, and the first axial surface is directed away from the base wall to the outside, and
the cam defines a bore extending from the first axial surface to the second axial surface, the carriage further including:
a fastener at least partially positionable through the bore and passable through the base wall to retain the cam immovably with the base wall.

7. The cam-based adjustable tension apparatus of claim 6, wherein
the cam defines a first opening of the bore at the first axial surface and a second opening of the bore at the second axial surface,
the bore being a stepped bore defining a stepped surface such that the first opening is larger than the second opening, wherein
a head portion of the fastener sits on or above the stepped surface, a shoulder portion of the screw passes through a part of the bore, and a threaded end of the screw passes at least partially into the base wall.

8. The cam-based adjustable tension apparatus of claim 7, further including a wave washer positioned in between the head portion and the stepped surface when the head portion of the screw sits above the stepped surface.

9. The cam-based adjustable tension apparatus of claim 7, wherein
the annular wall, the head portion, and the shoulder portion correspondingly define rotary surfaces such that the cam is rotatable and slidable relative to the fastener about the cam axis and within the well, and
the cam defines an engagement feature, the linear positioning stage including a tool defining a mating arrangement to engage with the engagement feature to rotate the cam about the cam axis.

10. The cam-based adjustable tension apparatus of claim 1, wherein the leaf spring structure is formed by wire cutting a part of a main stage of the linear positioning stage such that:
a cutting seam is formed in the main stage dividing a first part of the main stage from a second part of the main stage, the first part corresponding to the main carriage body and the second part corresponding to the leaf spring structure, and
the leaf spring structure extends integrally and contiguously from at least one part of the main carriage body to be connected to the main carriage body.

11. A linear positioning stage, comprising:
a support structure;
at least one rail coupled to and extending longitudinally along a linear axis or a length of the support structure; and
a carriage for the support structure, the carriage configured to be loaded and moved along the at least one rail, the carriage including:
a main carriage body;
a leaf spring structure connected to the main carriage body;
a contact surface rotatably coupled to the leaf spring structure and configured to slide or roll against the at least one rail to guide the main carriage body along the at least one rail; and
a cam rotatably couplable with the main carriage body, the cam defining a cam surface in contact with the leaf spring structure, wherein
a rotation of the cam about a cam axis of the cam varies an impinging force of the cam against the leaf spring structure enabling the leaf spring structure to flex with respect to the main carriage body and move or impinge the contact surface relative to the at least one rail such that a preload force exerted by the contact surface on the at least one rail is adjusted.

12. The linear positioning stage of claim 11, wherein
the rotation selectively corresponds to a first rotation of the cam in a first angular direction about the cam axis and a second rotation of the cam in a second angular direction about the cam axis, the second angular direction being opposite to the first angular direction,
the first rotation induces the impinging force against the leaf spring structure enabling the leaf spring structure to flex away from a home position to an extended position with respect to the main carriage body and push the contact surface against the at least one rail such that the preload force exerted by the contact surface on the at least one rail is increased, and
the second rotation reduces the impinging force against the leaf spring structure enabling the leaf spring structure to revert towards the home position with respect to the main carriage body and move the contact surface away from the at least one rail such that the preload force exerted by the contact surface on the at least one rail is decreased.

13. The linear positioning stage of claim 11, wherein
the main carriage body defines a first outer surface and the leaf spring structure defines a second outer surface, and
the first outer surface and the second outer surface are defined along a common plane and are flush with each other defining a work surface of the linear positioning stage.

14. The linear positioning stage of claim 11, wherein the cam includes a first axial surface and a second axial surface opposite to the first axial surface, the first axial surface exposed to an outside of the linear positioning stage and defining a rotary scale about the cam axis.

15. The linear positioning stage of claim 11, wherein the cam includes a first axial surface and a second axial surface opposite to the first axial surface, the first axial surface exposed to an outside of the linear positioning stage, and
the main carriage body defines a well delimited by an inner surface of the main carriage body, and the cam is positioned within the well such that the first axial surface is positioned either flush with a work surface of the linear positioning stage or is positioned at a lower elevation relative to the work surface of the linear positioning stage.

16. The linear positioning stage of claim 15, wherein
the inner surface is defined by a base wall and an annular wall of the main carriage body, the annular wall surrounds the base wall, the second axial surface is directed towards the base wall, and the first axial surface is directed away from the base wall to the outside, and
the cam defines a bore extending from the first axial surface to the second axial surface, the carriage further including:
a fastener at least partially positionable through the bore and passable through the base wall to retain the cam immovably with the base wall.

17. The linear positioning stage of claim 16, wherein
the cam defines a first opening of the bore at the first axial surface and a second opening of the bore at the second axial surface,
the bore being a stepped bore defining a stepped surface such that the first opening is larger than the second opening, wherein
a head portion of the fastener sits on or above the stepped surface, a shoulder portion of the screw passes through a part of the bore, and a threaded end of the screw passes at least partially into the base wall.

18. The linear positioning stage of claim 17, further including a wave washer positioned in between the head portion and the stepped surface when the head portion of the screw sits above the stepped surface.

19. The linear positioning stage of claim 17, wherein
the annular wall, the head portion, and the shoulder portion correspondingly define rotary surfaces such that the cam is rotatable and slidable relative to the fastener about the cam axis and within the well, and
the cam defines an engagement feature, the linear positioning stage including a tool defining a mating arrangement to engage with the engagement feature to rotate the cam about the cam axis.

20. The linear positioning stage of claim 11, wherein the leaf spring structure is formed by wire cutting a part of a main stage of the linear positioning stage such that:
a cutting seam is formed in the main stage dividing a first part of the main stage from a second part of the main stage, the first part corresponding to the main carriage body and the second part corresponding to the leaf spring structure, and
the leaf spring structure extends integrally and contiguously from at least one part of the main carriage body to be connected to the main carriage body.

21. A carriage for a support structure of a linear positioning stage, the carriage comprising:
a main carriage body;
a leaf spring structure connected to the main carriage body;
an abutting structure defining a contact surface configured to slide or roll against a rail of the linear positioning stage to guide the main carriage body along the rail; and
a force-adjusting element configured to be manipulated with respect to the main carriage body, wherein
a manipulation of the force-adjusting element varies an impinging force against the leaf spring structure enabling the leaf spring structure to flex with respect to the main carriage body and move the contact surface relative to the rail such that a preload force exerted by the contact surface on the rail is adjusted.

22. The carriage of claim 21, wherein
the force-adjusting element includes at least one of a cam and a screw, and
the manipulation of the force-adjusting element corresponds to a rotation of the cam or the screw about an axis to vary the impinging force of the cam or the screw against the leaf spring structure enabling the leaf spring structure to flex with respect to the main carriage body and move the contact surface relative to the rail such that the preload force exerted by the contact surface on the rail is adjusted.

23. The carriage of claim 22, wherein
the rotation selectively corresponds to a first rotation of the cam or the screw in a first angular direction about the axis and a second rotation of the cam or the screw in a second angular direction about the axis, the second angular direction being opposite to the first angular direction,
the first rotation induces the impinging force against the leaf spring structure enabling the leaf spring structure to flex away from a home position to an extended position with respect to the main carriage body and push the contact surface against the rail such that the preload force exerted by the contact surface on the rail is increased, and
the second rotation reduces the impinging force against the leaf spring structure enabling the leaf spring structure to revert towards the home position with respect to the main carriage body and move the contact surface away from the rail such that the preload force exerted by the contact surface on the rail is decreased.
